(19) United States
(12) Patent Application Publication
(10) Pub. No.: US 2010/0272829 A1
(43) Pub. Date: Oct. 28, 2010

(54) COMPOSITION FOR TRANSDERMAL OR TRANSMUCOSAL ADMINISTRATION

(76) Inventor: Yasuhiro Hidaka, Sakai (JP)

Correspondence Address: WENDEROTH, LIND & PONACK, L.L.P., 1030 15th Street, N.W.,, Suite 400 East, Washington, DC, 20005-1503, US

(21) Appl. No.: 12/733,901

(22) PCT Filed: Sep. 29, 2008
(86) PCT No.: PCT/JP2008/002704

§ 371 Date: Mar. 26, 2010

(30) Foreign Application Priority Data
Oct. 1, 2007 (JP) 2007-280961

(51) Int. Cl. A01N 55/02; A01N 59/20; A01P 1/00; A01P 3/00; A01P 9/00; A01P 13/00; A01N 55/08; C09D 5/16

(52) U.S. Cl. 424/635; 514/186; 514/64; 106/18.3; 106/18.33

(57) ABSTRACT

It is required to devise a way to reduce the amount of zinc pyrithione added to hair care products as an anti-dandruff agent so as to decrease stimulation to the ocular mucosa, and to reduce an influence on the environment of domestic wastewater, and a way to accelerate the decomposition of zinc pyrithione in sewage treatment facilities, rivers, lakes and ponds.

Furthermore, zinc pyrithione used as an antifouling agent for ship-bottom paints is eluted from a coating film at a high rate and thus results in poor long-term antifouling effect, so that it is also required to devise a way to decrease the solubility thereof in seawater.

These problems could be solved at once by an antibiotic composition obtained by adsorbing zinc pyrithione or a zinc pyrithione/zinc oxide composite compound to hydrous titanium oxide.

### TECHNICAL FIELD

The present invention relates to an antibiotic composition including zinc pyrithione or a zinc pyrithione/zinc oxide composite compound and hydrous titanium oxide, and a process for producing the same.

### BACKGROUND ART

Commonly, metal adsorption capacity and ion exchange capacity of hydrous titanium oxide are well known. An attempt is made to develop it as an uranium extractant from seawater, utilizing the characteristics (Non-Patent Document 1). An antimicrobial agent including hydrous titanium oxide as a carrier and silver ions adsorbed on the hydrous titanium oxide is also known (Patent Document 1). However, neither an antibiotic composition including hydrous titanium oxide, and an organometal salt or an organometal complex adsorbed to the hydrous titanium oxide, nor an antibiotic composition including hydrous titanium oxide and zinc pyrithione adsorbed to the hydrous titanium oxide is known.

### Patent Document 1:

Japanese Unexamined Patent Publication (Kokai) No. 6-298532

### Non-Patent Document 1:

Encyclopedia of Chemical Technology, 4th ed., Vol. 24, pp. 235

### DISCLOSURE OF THE INVENTION

### Problems to be Solved by the Invention

Zinc pyrithione has hitherto been used as an anti-dandruff agent over 40 years. However, it is required to devise a way to reduce the amount of zinc pyrithione added to hair care products such as shampoo so as to decrease stimulation to the ocular mucosa and to reduce an influence on the environment of domestic wastewater.

Furthermore, zinc pyrithione used as an antifouling agent for ship-bottom paints is eluted from a coating film at a high rate, so that it is also required to devise a way to decrease the solubility thereof in seawater so as to realize the long-term antifouling effect.

### Means for Solving the Problems

In order to solve these problems, the present inventors have considered that, when zinc pyrithione is used in combination with other substances or adsorbed to a carrier, it might be possible to increase the antibiotic activity, more specifically the antibacterial activity against Malassezia furfur as pathogenic bacteria which cause dandruff and to decrease the solubility thereof in seawater, and thus enabling inhibition of breeding and growth of organisms such as acorn barnacles, shellfishes and seaweeds which are adhered and grown on such as ship-bottom paints and fishing nets.

The present inventors have intensively studied so as to solve these problems and found that these problems can be solved at once by a composition obtained by mixing zinc pyrithione or a zinc pyrithione/zinc oxide composite compound represented by the general formula (I) of the present invention with hydrous titanium oxide, preferably adsorbing the zinc pyrithione or a zinc pyrithione/zinc oxide composite compound to the hydrous titanium oxide. Thus, the present invention has been completed.

The present invention provides:

(I) an antibiotic composition including:

zinc pyrithione or a zinc pyrithione/zinc oxide composite compound represented by the general formula (I):

xZnO.Zn(Py)₂ (I)

wherein Py represents 2-pyridylthio-N-oxide, and x represents 0 or a positive number, which satisfies a relation: 0≦x≦1, and

hydrous titanium oxide represented by the general formula (II):

TiO₂.nH₂O (II)

wherein n represents 1 or 2;
(2) the antibiotic composition according to (1), which is an anti-dandruff agent;
(3) the antibiotic composition according to (1), which is an underwater antifouling agent;
(4) the antibiotic composition according to (3), which further contains a binder, an inorganic copper compound, and/or an inorganic zinc compound, and/or copper pyrithione, and/or a triphenylborane compound;
(5) a process for producing an antibiotic composition, which includes stirring zinc pyrithione or a zinc pyrithione/zinc oxide composite compound represented by the general formula (I);

xZnO.Zn(Py)₂ (I)

wherein Py represents 2-pyridylthio-N-oxide, and x represents 0 or a positive number, which satisfies a relation: 0≦x≦1, and

hydrous titanium oxide represented by the general formula (II):

TiO₂.nH₂O (II)

wherein n represents 1 or 2, in a water suspension at a pH of 5 to 10 and a temperature of 10 to 100° C., thereby adsorbing the zinc pyrithione or zinc pyrithione/zinc oxide composite compound to the hydrous titanium oxide;
(6) the process for producing an antibiotic composition according to (5) wherein a weight ratio of the hydrous titanium oxide to the zinc pyrithione or zinc pyrithione/zinc oxide composite compound is from 1 to 50% by weight; and
(7) the process for producing an antibiotic composition according to (5) or (6), wherein x in the general formula (I) satisfies a relation: 0.01≦x≦0.5, and n in the general formula (II) is 1.

The antibiotic composition of the present invention includes a composition which has the antibacterial activity against Malassezia furfur as pathogenic bacteria which cause dandruff on the scalp, and the effect of preventing adhesion and inhabitation of pollutants in water, such as acorn barnacles, shellfishes and seaweeds which adhere and inhabit on ship-bottom paints and fishing nets thereby causing damage to the ship-bottom paints and fishing nets.

The antibiotic composition of the present invention is an antibiotic composition including hydrous titanium oxide in an amount of 1 to 50% by weight, and preferably 5 to 25% by weight, based on zinc pyrithione or a zinc pyrithione/zinc oxide composite compound of the general formula (I). When the weight ratio of the hydrous titanium oxide to the zinc pyrithione or zinc pyrithione/zinc oxide composite compound is less than the above lower limit, it is impossible to increase the antibacterial activity against Malassezia furfur and to decrease the solubility in seawater by adsorption of the zinc pyrithione or zinc pyrithione/zinc oxide composite compound to the hydrous titanium oxide. Even when the weight ratio exceeds the above upper limit, it is impossible to further increase these effects.

The antibiotic composition of the present invention can be obtained by mixing a powder of the zinc pyrithione or zinc pyrithione/zinc oxide composite compound with a powder of the hydrous titanium oxide, or combining a water-based suspension of the zinc pyrithione or zinc pyrithione/zinc oxide composite compound with a powder or a water-based slurry of the hydrous titanium oxide to give a water-based suspension, followed by stirring at a pH of 5 to 10, preferably 6 to 9, and a temperature of 10 to 100° C., preferably 20 to 70° C. The stirring time varies depending on an amount to be treated, but is usually from 5 minutes to 4 hours, and preferably from 10 minutes to 2 hours.

As a form of products of the biotic composition, a water-based suspension containing 40 to 60% of the antibiotic composition of the present invention is preferred as an anti-dandruff agent for shampoo, while an oil-based suspension containing 40 to 60% of the antibiotic composition of the present invention such as xylene is preferred as an underwater antifouling agent for ship-bottom paints.

The zinc pyrithione or zinc pyrithione/zinc oxide composite compound, which constitutes the antibiotic composition of the present invention, is used as it is in the form of a powder, or a water-based suspension or oil-based suspension. In the case of the water-based suspension, a water-based suspension obtained by reacting sodium pyrithione with a zinc salt in a water medium may be used as it is after adjusting the pH within a range from 5 to 10.

Zinc pyrithione is commercially available on the market and includes, for example, “Clean-Bio ZP” manufactured by Kolon Life Science Inc., “Zinc Omadine Powder” manufactured by Arch Chemicals, Inc., and “TOMICIDE ZPT” manufactured by API Corporation. As the zinc pyrithione/zinc oxide composite compound, those produced by using the synthesis method described in WO 2005/040122 A1 can be used.

x in the above general formula (I) is preferably a positive number which satisfies a relation: 0.01≦x≦0.5, more preferably a relation: 0.02≦x≦0.03.

The hydrous titanium oxide constituting the antibiotic composition of the present invention has the molecular formula: TiO₂.H₂O or TiO₂.2H₂O. When titanium tetrachloride is neutralized at 40° C. or lower, for example, 30° C., TiO₂.2H₂O is obtained, while TiO₂.H₂O is obtained when neutralized at a high temperature, for example, 60° C. TiO₂.2H₂O is called orthotitanic acid, while TiO₂.H₂O is called metatitanic acid. Particularly, metatitanic acid TiO₂.H₂O is obtained by pyrohydrolysis of a titanium sulfate solution in the production process of titanium dioxide by a sulfuric acid method, and a commercially available product thereof include, for example, a water-based slurry (containing 30% by weight) or a powder product “AMT-100” manufactured by TAYCA CORPORATION. Almost all of the particle diameter, as measured by Laser Diffraction/Scattering Particle Size Distribution Analyzer (HORIBA, Ltd. LA-920), of these products is within a range from several tens of 10 nm to 2 μm for a water-based slurry product, or within a range from 0.4 to 20 μm for a powder product. The hydrous titanium oxide has a terminal hydroxyl group and a bridge-forming hydroxyl group in a crystal structure, and it is presumed that the hydroxyl groups are combined with the zinc pyrithione or zinc pyrithione/zinc oxide composite compound to form a mild hydrogen bond in the antibiotic composition of the present invention. Furthermore, metatitanic acid has the effect of contacting with water to form a network structure thereby adjusting the solubility or elution rate of the zinc pyrithione or zinc pyrithione/zinc oxide composite compound in water. Therefore, in the present invention, metatitanic acid is more preferable than orthotitanic acid. When the hydrous titanium oxide is composed of metatitanic acid and orthotitanic acid, the content of the metatitanic acid is preferably 50% by weight, and more preferably 70% by weight or more.

Since the antibiotic composition of the present invention has the antibacterial activity, which is 2 to 4 times stronger than that of zinc pyrithione, against Malassezia furfur as main pathogenic bacteria which cause dandruff, the amount of zinc pyrithione to be added in an anti-dandruff shampoo or an anti-dandruff hair conditioner can be decreased. Since the antibiotic composition is easily photolyzed under acidic conditions as compared with zinc pyrithione, the residual amount of zinc pyrithione in sewage treatment facilities in which the solution tends to shift to the acidic side can be decreased. These features are considered to be notable properties since they meet the demands of the present age, such as improvement in safety to consumers and a decrease of an environmental risk. The composition of the present invention is mixed with a shampoo or a hair conditioner in an amount within a range from 0.1 to 0.2% by weight, and preferably from 0.2 to 1.0% by weight.

As a base of the shampoo, anionic, nonionic and amphoteric surfactants having excellent detergency and high safety are used. As a base of the hair conditioner, a cationic surfactant is used. Examples of the surfactants include anionic surfactants such as sodium lauryl sulfate, triethanolamine lauryl sulfate, sodium polyoxyethylene sulfate, and ammonium polyoxyethylene sulfate; nonionic surfactants such as polyoxyethylene sorbitan stearate and polyethylene glycol distearate; amphoteric surfactants such as coconut oil fatty acid amidopropyl betaine; and cationic surfactants such as cetyltrimethylammonium chloride. In addition, purified water, a foam producing agent, a thickener, a solubilizing agent, a flavor, a coloring agent and a preservative may be used and, if desired, a pharmaceutically active component such as dipotassium glycyrrhizinate, and a functional component such as organopolysiloxane may be used.

The solubility of the antibiotic composition of the present invention in seawater accounts for about 60% (in terms of zinc pyrithione) of the solubility of zinc pyrithione. Zinc pyrithione is not necessarily suited for use an antifouling agent of a ship-bottom paint for which long-term antifouling lifetime is required because of its quick elution. Since the lifetime of the antifouling agent to be eluted from a coating film is in inversely proportional to the square of the solubility of the antifouling agent in seawater, the antifouling lifetime of the coating film containing the composition of the present invention is at least 2 times longer than that of zinc pyrithione. Therefore, the antibiotic composition of the present invention can broad applications of zinc pyrithione as an underwater antifouling agent with long-term antifouling effect durability. Particularly, the composition with the zinc pyrithione/zinc oxide composite compound having excellent stability to copper ions of the present invention can be used in combination with cuprous oxide, and also can broad the range of applications as the underwater antifouling agent. The ship-bottom antifouling paint can contain the composition in a concentration of 0.1 to 15% by weight, and preferably 1 to 5% by weight, while the fishing net antifouling agent can contain the composition in a concentration of 0.1 to 15% by weight, and preferably 1 to 7% by weight.

As a binder of the ship-bottom paint, for example, an acrylic resin, a vinyl resin and chlorinated rubber are used. Particularly, the acrylic resin is preferably an acrylic resin in which an organosilicon group, or an organic acid group via zinc or copper is bonded to a portion of acrylic acid groups so as to impart self-abrading properties, and the resin gradually becomes water soluble by hydrolysis.

Zinc pyrithione as the underwater antifouling agent is effective for algae, but is not necessarily effective for animal-based sessile organisms such as acorn barnacles. Therefore, it is usually possible to use cuprous oxide, copper rhodanide, zinc oxide, and a triphenylborane compound such as triphenylborane pyridine salt alone or in combination.

In the antibiotic composition of the present invention, it is preferred to use, as the underwater antifouling agent, cuprous oxide, copper rhodanide, zinc oxide and a triphenylborane pyridine salt in combination. It is also possible to use copper pyrithione, zinc ethylenebisdithiocarbamate, zinc dimethyldithiocarbamate and tetramethylthiuram disulfide alone or in combination.

In addition, a solvent such as xylene is used as an indispensable component of a paint formulation, and it is adjusted to a proper pigment volume concentration (PVC) using a color pigment or an extender pigment. If desired, a rosin, a viscosity modifier, an antisetting agent and an antisagging agent may be used so as to control elution of cuprous oxide and copper rhodanide and to improve coating film properties.

It is possible to use, as the fishing net antifouling agent, indispensable components, for example, a binder such as acrylic resin, a solvent such as xylene, and one or more kinds of copper powder, cuprous oxide, glass copper, a triphenylborane compound and zinc oxide, which are effective for preventing adhesion of animal-based sessile organisms, a dithiocarbamic acid heavy metal salt compound which is particularly useful for preventing adhesion of hydrozoan in combination. It is also possible to use in combination with an elution adjustment/efficacy enhancing agent such as t-nonyl polysulfide.

### EFFECTS OF THE INVENTION

The antibiotic composition including zinc pyrithione, a zinc pyrithione/zinc oxide composite compound and hydrous titanium oxide of the present invention has higher anti-dandruff effect than that of zinc pyrithione in hair care applications, and can prolong antifouling lifetime as an underwater antifouling agent.

### BEST MODE FOR CARRYING OUT THE INVENTION

The present invention will be described more specifically by way of examples.

### Example 1

9.8 g of a hydrous titanium oxide powder (TiO₂.H₂O) (“AMT-100”, manufactured by TAYCA CORPORATION) and 25.6 g of a zinc pyrithione powder (“Clean-Bio ZP”, manufactured by Kolon Life Science Inc.) were uniformly mixed and grounded by a mixer with a blade to obtain 35.0 g of a composition of zinc pyrithione and hydrous titanium oxide in a weight ratio of 8:1.

### Example 2

1.2 g of a hydrous titanium oxide (TiO₂.H₂O) water-based slurry (containing 30% by weight of titanium oxide, manufactured by TAYCA CORPORATION) and 30 mL of purified water were charged in a 100 mL beaker to give a water-based suspension (pH of about 3). To this water-based suspension, 0.5 g of sodium carbonate was added and, furthermore, 2.6 g of a zinc pyrithione powder (manufactured by Arch Chemicals, Inc.) and 20 mL of purified water were added, followed by stirring under light shielding condition at 20° C. for 30 minutes (pH of about 8.5). The suspension was filtered through No. 2 filter paper, washed with 30 mL of purified water and then dried under light shielding condition to obtain 2.7 g of a white powder. 800 mg of the resultant white powder was added to 500 mL of chloroform in a 1 L three-necked flask, followed by stirring at 60° C. for 30 minutes and further filtration with a membrane filter. The filtrate was distilled off to obtain 670 mg of the residue. The content of the filtration residue was 120 mg.

The resultant distillation residue was subjected to X-ray fluorescence spectrometry. As a result, titanium was not detected. Therefore, it is considered that zinc pyrithione and hydrous titanium oxide do not form a composite compound such as a zinc pyrithione/zinc oxide composite compound which is directly extracted with chloroform.

### Example 3

40 g of a zinc pyrithione powder (manufactured by Kolon Life Science Inc.) and 1,500 mL of purified water were charged in a 5 L flask and 16 g of a 30% hydrous titanium oxide (TiO₂.H₂O) water-based slurry (manufactured by TAYCA CORPORATION) was added, and the pH was adjusted to 8 with an aqueous 1% sodium hydroxide solution, followed by stirring under light shielding condition at 20° C. for 60 minutes. The operation of filtration through No. 2 filter paper, returning to 500 ml of purified water and filtration was repeated three times. The resultant white solid was dried under light shielding condition at 50° C. for 5 hours to obtain 42 g of a white powder.

### Example 4

In the same manner as in Example 3, except that the pH was adjusted to 9.5 with an aqueous 1% sodium hydroxide solution and stirring was performed under light shielding condition at 20° C. for 60 minutes, a test was performed. After drying, 41 g of a white powder was obtained.

In the same manner as in Example 1, extraction with chloroform was performed and the filtrate was distilled off to obtain 710 mg of the residue. The content of the filtration residue was 90 mg. The resultant extracted with chloroform was subjected to X-ray fluorescence spectrometry. As a result, titanium was not detected. Therefore, it is considered that zinc pyrithione and hydrous titanium oxide do not form a composite compound such as a zinc pyrithione/zinc oxide composite compound even when prepared at high pH.

### Example 5

In a 500 mL round-bottom flask, 90 mL of an aqueous solution containing 1.0 g (0.024 mol) of sodium hydroxide, 35.8 g (0.096 mol) of an aqueous 40% sodium pyrithione solution and 50 mL of water were charged and 200 mL of an aqueous solution containing 17.3 g (0.06 mol) of zinc sulfate heptahydrate was added dropwise under stirring over 60 minutes while maintaining the temperature at 20° C. Furthermore, the pH was adjusted to 9.5 with concentrated hydrochloric acid and stirring was continued at 20° C. for 4 hours. The reaction solution was filtered through No. 2 filter paper to obtain a solid. It was confirmed that the filtrate is not colored with ferrous ions by backwashing twice with 100 mL of water. The resultant solid was then washed with 70 mL of water, dried at 50° C. for 5 hours and then ground to obtain 15.8 g of a zinc pyrithione/zinc oxide composite compound (x=0.25) as a white powder (A). As a result of DTA/TG analysis, an exothermic peak temperature was 328.7° C. (before correction) or 302.0° C. (after correction).

In a 1 L flask, 5 g of a 30% hydrous titanium oxide (TiO₂.H₂O) slurry (manufactured by TAYCA CORPORATION) was added to 400 mL of water and the pH was adjusted to 8 with 1% sodium hydroxide. 12 g of (A) was added, followed by stirring at under light shielding condition at 20° C. for 60 minutes. The water-based suspension was filtered with No. 2 filter paper and backwashed with 200 mL of water, and then the solid collected by filtration was dried under light shielding condition at 50° C. for 5 hours and then ground. 13 g of a white powder (B) was obtained from the zinc pyrithione/zinc oxide composite compound (A) and the hydrous titanium oxide.

### Example 6

In the same manner as in Example 3, except that the pH of a water-based suspension containing a hydrous titanium oxide water-based slurry and a zinc pyrithione powder was adjusted to 7 with an aqueous 1% sodium hydroxide solution, followed by stirring under light shielding condition at 60° C. for 15 minutes, a test was performed. After drying, 40 g of a white powder was obtained.

### Example 7

The solubility of samples shown below in artificial sweater was measured.

Artificial sweater (pH of 7.8) was added to each sample shown below to make total amount of 500 mL, followed by shaking at 20° C. for 24 hours. After filtration, determination of zinc was performed by subjecting the filtrate to atomic absorption spectrometry.

Sample 1: 110 mg of white powder of Example 2 (zinc pyrithione:hydrous titanium oxide=8:1, in weight ratio)
Sample 2: 100 g of zinc pyrithione (manufactured by Arch Chemicals, Inc.)

Artificial seawater was prepared according to the formulation shown in Table 1.

TABLE 1
Formulation of artificial seawater (total amount: 1 L, pH 7.8)

| Components | Content (g/L) |
|---|---|
| NaCl | 24.53 |
| MgCl₂•6H₂O | 11.11 |
| Na₂SO₄ | 4.09 |
| CaCl₂ | 1.54 |
| KCl | 0.695 |
| NaHCO₃ | 0.201 |
| KBr | 0.100 |
| H₃BO₃ | 0.027 |
| SrCl₂•6H₂O | 0.042 |
| NaF | 0.003 |
| Purified water | Balance |

The measurement results are shown in Table 2.

TABLE 2
Solubility in artificial seawater I (mg/L)

| | Quantitative value of zinc | Value in terms of zinc |
|---|---|---|
| Samples | (mg/L) | pyrithione (mg/L) |
| Samples 1 | 0.70 | 3.40 |
| Samples 2 | 1.16 | 5.64 |

As is apparent from Table 2, the solubility of the composition including zinc pyrithione and hydrous titanium oxide of the present invention is lowered in artificial seawater as compared with zinc pyrithione (decrease ratio of 40%)

From the results, it is presumed that the solubility of zinc pyrithione in artificial seawater was remarkably decreased as a result of adsorption of zinc pyrithione to hydrous titanium oxide. That is, it is considered that zinc pyrithione and hydrous titanium do not form a simple mixture, but is a kind of a composite-like composition.

### Example 8

In the same manner as in Example 6, the solubility of samples shown below in artificial seawater was measured.

Sample 3: 110 g of white powder of Example 3 (zinc pyrithione:hydrous titanium oxide=8:1, in weight ratio)
Sample 4: 110 mg of white powder of Example 4 (zinc pyrithione:hydrous titanium oxide=8:1, in weight ratio)
Sample 5: 100 mg of zinc pyrithione+80 mg of 30% hydrous titanium oxide (TiO₂.H₂O) slurry (zinc pyrithione:hydrous titanium oxide (in terms of 100%)=4:1)
Sample 6: 100 mg of zinc pyrithione (manufactured by Kolon Life Science Inc.)
Sample 7: 125 mg of white powder of Example 5+40 mg of 30% hydrous titanium oxide slurry (A:hydrous titanium oxide (in terms of 100%)=4:1)
Sample 8: 125 g of white powder (A) of Example 5

TABLE 3
Solubility in artificial seawater II (mg/L)

| | Quantitative value of zinc | Value in terms of zinc |
|---|---|---|
| Samples | (mg/L) | pyrithione (mg/L) |
| Samples 3 | 0.68 | 3.33 (Decrease ratio 36%) |
| Samples 4 | 0.94 | 4.61 (Decrease ratio 12%) |
| Samples 5 | 0.63 | 3.09 (Decrease ratio 41%) |
| Samples 6 | 1.07 | 5.24 |
| Samples 7 | 3.34 | — |
| | | Decrease ratio is 11% |
| | | relative to sample 8 |
| Samples 8 | 3.77 | — |

In Table 3, quantitative values of zinc of samples 7 and 8 mean quantitative values of zinc derived from zinc pyrithione and zinc oxide. Therefore, the value in terms of zinc pyrithione in the right column cannot be calculated and is expressed by the symbol “−”.

As is apparent from Table 3, 1) when zinc pyrithione is treated with hydrous titanium oxide at high pH (9.5), the solubility decreasing effect decreases, in other words, the adsorption capacity of hydrous titanium oxide to zinc pyrithione lowers, and 2) it is presumed that the solubility decreasing effect is scarcely exerted by the zinc oxide moiety in the zinc pyrithione/zinc oxide composite compound. That is, it is considered that hydrous titanium oxide has stronger affinity with zinc pyrithione than that of zinc oxide.

### Example 9

The following water suspension samples are charged in a glass bottle, allowed to stand outside for 10 days, dried and ground, and then yellowness (b* value) was measured by a colorimeter.

Sample 9: 1 g of zinc pyrithione+20 mL of distilled water
Sample 10: 1 g of zinc pyrithione+400 mg of 30% hydrous titanium oxide (TiO₂.H₂O) slurry+20 mL of distilled water (pH is adjusted to 5 with sodium bicarbonate)
Sample 11: 1 g of A of Example 5+20 mL of distilled water (pH is adjusted to 5 with sodium bicarbonate)
Sample 12: 1 g of A of Example 5+400 mg of 30% hydrous titanium oxide slurry+20 mL of distilled water (pH is adjusted to 5 with sodium bicarbonate)
Sample 13: 1 g of zinc pyrithione+20 mL of artificial seawater
Sample 14: 1.1 g of composition of Example 1+20 mL of artificial seawater
Sample 15: 1 g of A of Example 5+20 mL of artificial seawater
Sample 16: 1 g of A of Example 5+400 mg of 30% hydrous titanium oxide slurry+20 mL of artificial seawater

The measurement results are shown in Table 4.

TABLE 4
Yellowness of powder

| Samples | Yellowness (b* value) |
|---|---|
| Samples 9 | 8.80 |
| Samples 10 | 9.87 |
| Samples 11 | 5.68 |
| Samples 12 | 8.92 |
| Samples 13 | 11.07 |
| Samples 14 | 10.86 |
| Samples 15 | 8.12 |
| Samples 16 | 8.56 |

As is apparent from Table 4, 1) zinc pyrithione and a zinc pyrithione/zinc oxide composite compound are easily photolyzed at the alkali side as compared with the acidic side, 2) the photolysis promoting effect due to hydrous titanium oxide is exerted at pH 5, but is scarcely exerted in the case of artificial seawater, and 3) a zinc pyrithione/zinc oxide composite compound is not easily photolyzed as compared with zinc pyrithione.

### Example 10

With respect to the composition of zinc pyrithione and hydrous titanium oxide of Example 2, an antibacterial test (MIC) against Malassezia furfur by a liquid culture method was performed in comparison with zinc pyrithione.

Sample 17: Composition of zinc pyrithione (manufactured by Arch Chemicals, Inc.) and hydrous titanium oxide (Example 2)
Sample 18: Zinc pyrithione (manufactured by Arch Chemicals, Inc.)
Test fungi: Malassezia furfur NBRC 0656
Test medium: 1% olive oil is added to Sabouraud glucose medium
Test conditions: shaking culture at 30° C. for 4 days (120 rpm)

TABLE 5
Antibacterial test I (MIC) (μg/mL)

| | Malassezia furfur (Number of fungi: 10⁶cfu/mL) | |
|---|---|---|
| Samples | 2 days | 4 days |
| Sample 17: white | 0.78 | 1.56 |
| powder of Example 2 | | |
| Sample 18: zinc | 6.25 | 6.25 |
| pyrithione (control) | | |

As is apparent from Table 5, the composition of zinc pyrithione and hydrous titanium oxide exhibited antibacterial activity, which is 4 times stronger than that of zinc pyrithione, against Malassezia furfur.

### Example 11

With respect to the composition of zinc pyrithione and hydrous titanium oxide (Example 3), an antibacterial test (MIC) against Malassezia furfur by an agar medium was performed in comparison with zinc pyrithione.

Sample 19: Composition of zinc pyrithione (manufactured by Kolon Life Science Inc.) and hydrous titanium oxide (Example 3)
Sample 20: Zinc pyrithione (manufactured by Kolon Life Science Inc.)
Test fungi: Malassezia furfur NBRC 0656
Test medium: YM agar medium added with olive oil
Test conditions: culture at 28° C. for 7 days

TABLE 6
Antibacterial test II (MIC) (μg/mL)

| | Malassezia furfur (Number of fungi: 10⁵cfu/mL) |
|---|---|
| Samples | 7 days |
| Sample 19: white | 3.12 |
| powder of Example 3 | |
| Sample 20: zinc | 6.25 |
| pyrithione (control)) | |

As is apparent from Table 6, the composition of zinc pyrithione and hydrous titanium oxide exhibited antibacterial activity, which is 2 times stronger than that of zinc pyrithione, against Malassezia furfur.

### Example 12

The following components were uniformly mixed to obtain a ship-bottom antifouling paint (Symbol W means weight).

| | |
|---|---|
| Copolymer of methyl methacrylate and isopropylsilyl | 36 W % |
| acrylate in mixing ratio of 2:3 (50% xylene solution) | |
| Cuprous oxide | 35 W % |
| Zinc white | 5 W % |
| Composition of B of Example 5 | 5 W % |
| Titanium white | 1 W % |
| Colcothar | 1 W % |
| Fatty acid amide wax (20%) | 2 W % |
| Xylene | 15 W % |
| Total | 100 W % |

### Example 13

The following components were uniformly mixed to obtain a fishing net antifouling agent (Symbol W means weight).

| | |
|---|---|
| Butyl acrylate/methyl methacrylate | 20 W % |
| copolymer (50 W % xylene solution) | |
| Triphenylboran pyridine salt | 6 W % |
| Composition of Example 6 | 2 W % |
| Zinc white | 9 W % |
| Polyether silicone oil | 2 W % |
| t-nonyl polysulfide | 3 W % |
| Xylene | 58 W % |
| Total | 100 W % |

### Example 14

The following components were uniformly mixed to obtain an anti-dandruff shampoo (Symbol W means weight).

| | |
|---|---|
| Sodium polyoxyethylene (EO = 2 mol) lauryl | 16.0 W % |
| ether sulfate | |
| Composition of Example 3 | 0.5 W % |
| Propylene glycol | 0.3 W % |
| Citric acid | trace amount |
| Purified water | balance |
| Total | 100.0 W % |

### INDUSTRIAL APPLICABILITY

The antibiotic composition including zinc pyrithione or a zinc pyrithione/zinc oxide composite compound represented by the general formula (I) and hydrous titanium oxide represented by the general formula (II) increases the antibacterial activity against Malassezia furfur as pathogenic bacteria which cause dandruff, and to increase photolysis capability under the acidic condition and to decrease the solubility in seawater, and therefore can be used as an excellent anti-dandruff agent and an excellent underwater antifouling agent as compared with zinc pyrithione.

1. An antibiotic composition comprising:
zinc pyrithione or a zinc pyrithione/zinc oxide composite compound represented by the general formula (I):
xZnO.Zn(Py)₂ (I)
wherein Py represents 2-pyridylthio-N-oxide, and x represents 0 or a positive number, which satisfies a relation: 0≦x≦1, and
hydrous titanium oxide represented by the general formula (II):
TiO₂.nH₂O (II)
wherein n represents 1 or 2.

2. The antibiotic composition according to claim 1, which is an anti-dandruff agent.

3. The antibiotic composition according to claim 1, which is an underwater antifouling agent.

4. The antibiotic composition according to claim 3, which further contains a binder, an inorganic copper compound, and/or an inorganic zinc compound, and/or copper pyrithione, and/or a triphenylborane compound.

5. A process for producing an antibiotic composition, which comprises stirring zinc pyrithione or a zinc pyrithione/zinc oxide composite compound represented by the general formula (I):
xZnO.Zn(Py)₂ (I)
wherein Py represents 2-pyridylthio-N-oxide, and x represents 0 or a positive number, which satisfies a relation: 0≦x≦1, and
hydrous titanium oxide represented by the general formula (II):
TiO₂.nH₂O (II)
wherein n represents 1 or 2, in a water suspension at a pH of 5 to 10 and a temperature of 10 to 100° C., thereby adsorbing the zinc pyrithione or zinc pyrithione/zinc oxide composite compound to the hydrous titanium oxide.

6. The process for producing an antibiotic composition according to claim 5, wherein a weight ratio of the hydrous titanium oxide to the zinc pyrithione or zinc pyrithione/zinc oxide composite compound is from 1 to 50% by weight.

7. The process for producing an antibiotic composition according to claim 5, wherein x in the general formula (I) satisfies a relation: 0.01≦x≦0.5, and n in the general formula (II) is 1.

8. The process for producing an antibiotic composition according to claim 6, wherein x in the general formula (I) satisfies a relation: 0.01≦x≦0.5, and n in the general formula (II) is 1.
